(19) United States
(12) Patent Application Publication
(10) Pub. No.: US 2013/0154269 A1
(43) Pub. Date: Jun. 20, 2013

(54) TURBINE GENERATORS AND SYSTEMS

(71) Applicant: Diana BALDWIN, Elgin, SC (US)

(72) Inventor: Diana BALDWIN, Elgin, SC (US)

(21) Appl. No.: 13/325,142

(22) Filed: Dec. 14, 2011

(51) Int. Cl. F03B 13/00; F01D 1/00

(52) U.S. Cl. 290/54; 415/220

(57) ABSTRACT

Turbines, turbine generators, and turbine generator systems are disclosed, which can supply electrical power to an electrical system. A turbine includes a duct including a first opening at a first end, a second opening at a second end, and a depression on an internal surface, as well as a rotor rotatably disposed on the duct and partially disposed within the depression. A turbine generator includes a turbine coupled to a generator. A turbine generator system includes a turbine generator coupled to an electrical system.

### BACKGROUND

Electricity is indispensable to the operation of most vehicles. It is required to operate most onboard equipment, including lights, radios, and refrigeration units. Moreover, certain electrically-powered vehicles consume electricity as a source of energy for motion.

However, storing and using electricity onboard conventional vehicles present several drawbacks. First, conventional vehicles store electricity in limited quantity in onboard batteries. These batteries require regular charging for proper functioning. Electricity onboard vehicles is conventionally produced using polluting fuels, such as gasoline, or using otherwise dangerous and environmentally harmful methods, such as nuclear fission.

Furthermore, the power contained in the fluid flow surrounding the vehicle is often dissipated through drag, and fails to be harnessed.

### SUMMARY

An exemplary embodiment of a turbine may include a duct including a first opening at a first end, a second opening at a second end, and a depression on an internal surface, as well as a rotor rotatably disposed on the duct and partially disposed within the depression.

An exemplary embodiment of a turbine generator may include a turbine coupled to a generator.

An exemplary embodiment of a turbine generator system may include a turbine generator coupled to an electrical system.

### BRIEF DESCRIPTION OF THE FIGURES

The present embodiments are illustrated by way of example and not limitation in the figures of the accompanying drawings, in which like references indicate similar elements and in which:

FIG. 1a illustrates a side view of an exemplary embodiment of a turbine;

FIG. 1b illustrates an isometric cut-away view of an exemplary embodiment of a turbine;

FIG. 2 illustrates a side view of an exemplary embodiment of a turbine with tapered ends;

FIG. 3 illustrates a side view of an exemplary embodiment of a turbine with a bent end;

FIG. 4a illustrates a side view of an exemplary embodiment of a turbine with flexible ends;

FIG. 4b illustrates a top view of an exemplary embodiment of a turbine with flexible ends;

FIG. 5 shows an exemplary embodiment of a turbine generator with one turbine;

FIG. 6 shows an exemplary embodiment of a turbine generator with two turbines;

FIG. 7 shows another exemplary embodiment of a turbine generator with two turbines;

FIG. 8 shows yet another exemplary embodiment of a turbine generator with two turbines;

FIG. 9a illustrates a side view of an exemplary embodiment of a turbine generator system with a watercraft;

FIG. 9b illustrates a top view of an exemplary embodiment of a turbine generator system with a watercraft;

FIG. 10 shows an exemplary embodiment of a turbine generator system with a trailer;

FIG. 11 shows an exemplary embodiment of a turbine generator system with an automobile;

FIG. 12 shows an exemplary embodiment of a turbine generator system with a fixed structure; and

FIG. 13 shows an exemplary embodiment of a turbine generator system with a fixed structure and a power grid.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein describe a turbine generator that may provide a means of supplying electrical power to a vehicle or to a power grid. The turbine generator may draw power from a fluid current, such as air or water.

A turbine generator system may include one turbine generator or several turbine generators arranged in an array. A turbine generator system may be coupled to a vehicle and connected to its electrical system, in order to reduce the need for other sources of energy. Alternatively, a turbine generator system may be coupled to a fixed structure and connected to a power grid, in order to supply power.

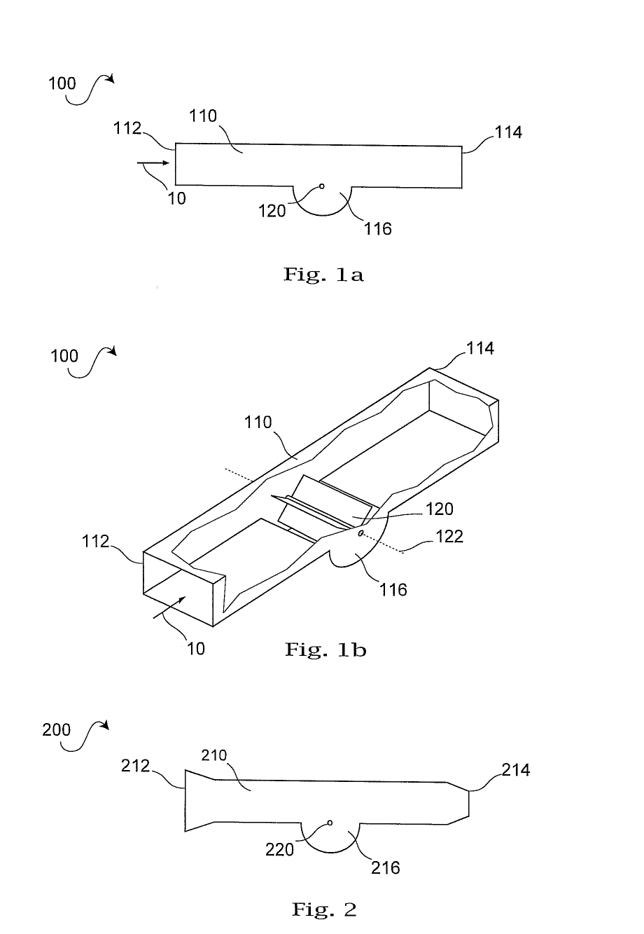

FIG. 1 shows an exemplary embodiment 100 of a turbine. The turbine may include a duct 110 and rotor 120. The duct 110 may include a first opening at a first end 112, a second opening at a second end 114, and a depression 116 on an internal surface. The rotor 120 may be rotatably disposed on the duct 110 and partially disposed within the depression 116. The cross section of the duct 110 may be rectangular, oval, or of any regular or irregular geometric shape.

In the exemplary embodiment 100, the duct may be adapted for fluid flow 10 from the first end to the second end. Fluid flow 10 may cause the rotor to rotate. The depression may be substantially semicylindrical to accommodate the rotor 120. A rotating axis 122 of the rotor 120 may be disposed at a right angle with respect to the direction of fluid flow 10. Alternatively, and depending on the type of rotor used, the rotating axis of the rotor may be disposed parallel or at any angle with respect to the direction of fluid flow 10. The rotor 120 may be any rotor known in the art. Fluid flow may include gas flow, liquid flow, solid particle flow, as well as atomic and subatomic particle flow, such as solar wind.

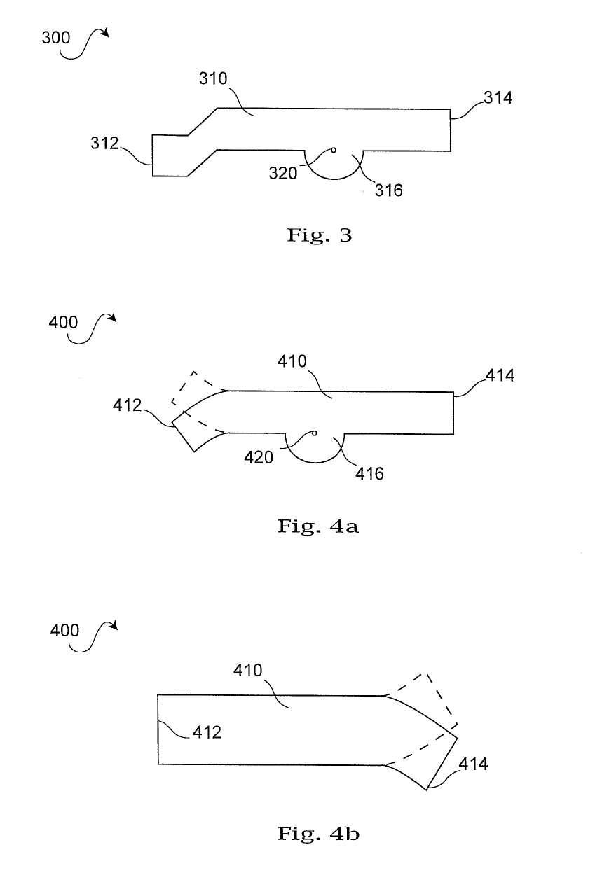

FIGS. 2, 3 and 4 illustrate other exemplary embodiments 200, 300 and 400, respectively, of the turbine. Many components of embodiments 200, 300 and 400 are the same or similar to those of embodiment 100, and are identified by similar numerals. Such components should be understood to have substantially similar characteristics and functionality in both embodiments.

In the exemplary embodiment 200, as in exemplary embodiment 100, the turbine may include a duct 210 and rotor 230. The first end 212 and the second end 214 may be tapered. Alternatively, the first end 212 and/or the second end 214 may be tapered.

In the exemplary embodiment 300, as in exemplary embodiment 100, the turbine may include a duct 310, an axle 320 and rotor 330. The first end 312 may bent or kinked. Alternatively, the first 312 end and/or the second end 314 may be bent or kinked.

In the exemplary embodiment 400, as in exemplary embodiment 100, the turbine may include a duct 410, an axle 420 and rotor 430. The first end 412 may be flexible about a horizontal axis, and the second end 414 may be flexible about a vertical axis.

Alternatively, the first end and/or the second end may be flexible. For example, the first end and/or the second end may be hinged, bendable, or otherwise flexible. Flexibility may allow for redirection of fluid flow, thereby minimizing or reducing drag.

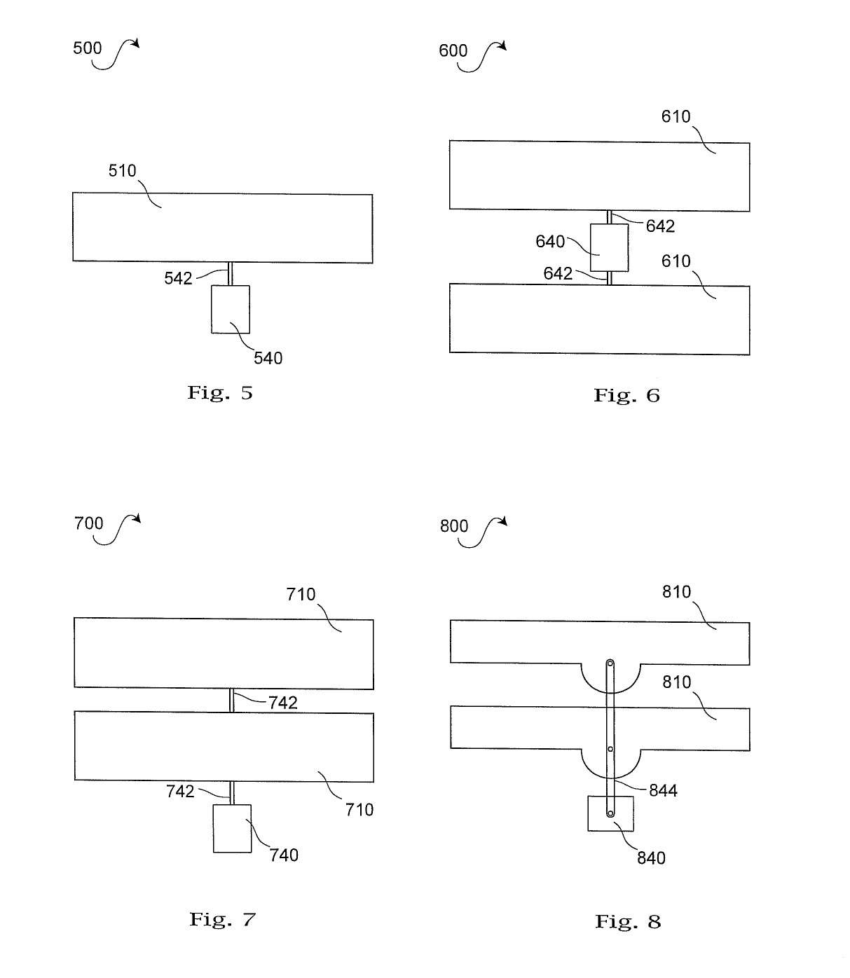

FIG. 5 shows an exemplary embodiment 500 of a turbine generator. The turbine generator may include a turbine 510 coupled to a generator 540 using a shaft connection 542. Alternatively, the turbine generator may include a plurality of turbines and/or a plurality of generators. Moreover, a turbine may be coupled to a generator using a shaft connection, a belt connection, gears, or any other connection or combination of connections known in the art. The generator 540 may be an electromagnetic generator. Alternatively, the generator may be an electrostatic generator, a linear generator, a magnetohydrodynamic generator, or any generator known in the art.

FIG. 6 shows another exemplary embodiment 600 of a turbine generator. The turbine generator may include two turbines 610 each coupled to a generator 640 using a shaft connection 642.

FIG. 7 shows another exemplary embodiment 700 of a turbine generator. The turbine generator may include two turbines 710 coupled to each other and to a generator 740 using a shaft connection 742.

FIG. 8 shows another exemplary embodiment 800 of a turbine generator. The turbine generator may include two turbines 810 coupled to a generator 840 using a belt connection 844.

Alternatively, one or any number of turbine generators may be connected to one or any number of electrical systems.

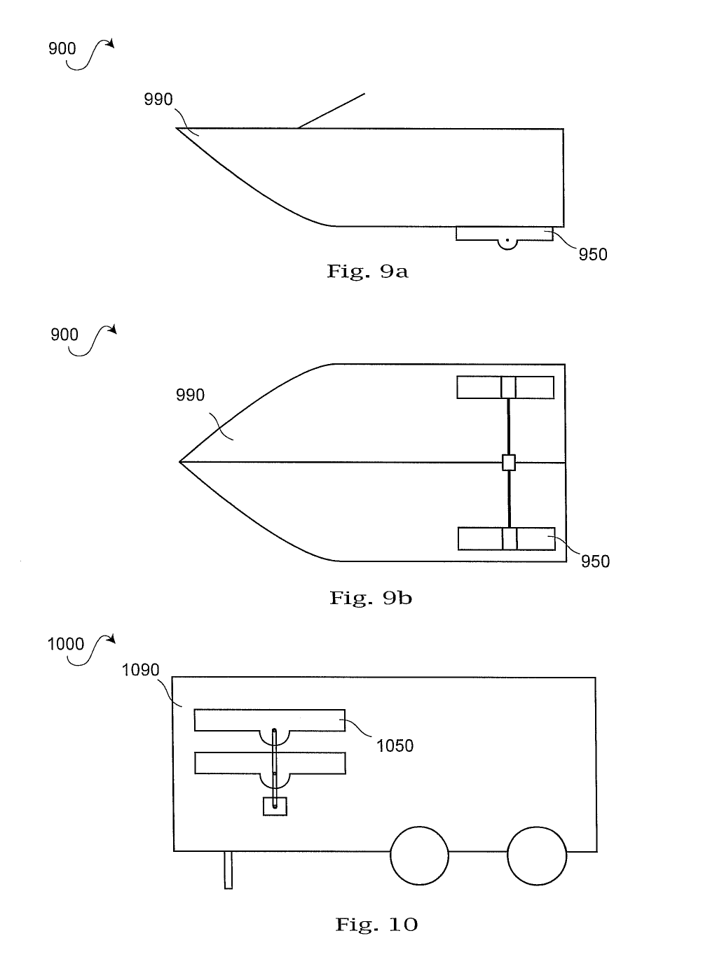

FIG. 9 shows an exemplary embodiment 900 of a turbine generator system. The turbine generator system may include a turbine generator 950 coupled to a watercraft 990. As the watercraft is set in motion, water flow may be created by the relative velocity of the watercraft and the water. The water flow may cause the rotor(s) to rotate and engage the turbine generator(s), thereby creating electricity. The electricity generated may be used to power the motion of the watercraft and/or onboard equipment.

Alternatively, the turbine(s) of the turbine generator may include a first end configured to hinge about a horizontal axis, and a second end configured to hinge about a vertical axis. The first opening may intake water from under the watercraft, in order to adjust to the pitch of the watercraft. The second opening may output water from behind the watercraft, in order to adjust to the turning radius of the watercraft.

Alternatively, the turbine generator may be coupled to any vehicle, including a land vehicle, a watercraft, an aircraft, a spacecraft, or any vehicle known in the art. The turbine generator may be coupled to an electrical circuit of the vehicle. Alternatively, a plurality of turbine generators may be coupled to a vehicle.

FIG. 10 shows an exemplary embodiment 1000 of a turbine generator system. The turbine generator system may include a turbine generator 1050 coupled to a trailer 1090. As the trailer is set in motion, air flow may be created by the relative velocity of the trailer and the local atmosphere. Alternatively, air flow may stem from local air currents. The air flow may cause the rotor(s) to rotate and engage the turbine generator(s), thereby creating electricity. The electricity generated may be used to power onboard equipment.

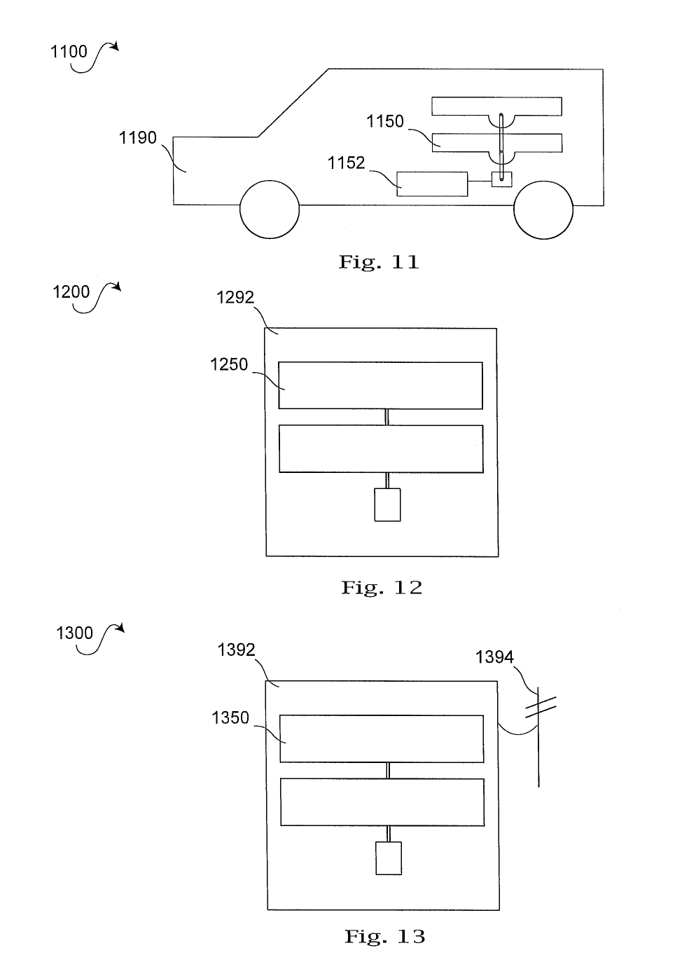

FIG. 11 shows an exemplary embodiment 1100 of a turbine generator system. The turbine generator system may include a turbine generator 1150 coupled to an emergency battery 1152 and an automobile 1190. The emergency battery 1152 may further supplement the electrical circuit of the automobile 1190, and may be charged by the turbine generator 1150. As the automobile is set in motion, air flow may be created by the relative velocity of the automobile and the local atmosphere. The air flow may cause the rotor(s) to rotate and engage the turbine generator(s), thereby creating electricity. The electricity generated may be used to power the motion of the automobile and/or onboard equipment.

FIG. 12 shows an exemplary embodiment 1200 of a turbine generator system. The turbine generator system may include a turbine generator 1250 coupled to a fixed structure 1292. The fixed structure 1292 may be a building, a pole, a lighting structure, a guardrail, or any other fixed structure known in the art. The turbine generator 1250 may provide power to the fixed structure 1292. Local fluid flow, such as, for example, air currents from passing cars, local air currents, water currents, or solar wind, may cause the rotor(s) to rotate and engage the turbine generator(s), thereby creating electricity.

FIG. 13 shows an exemplary embodiment 1300 of a turbine generator system. The turbine generator system may include a turbine generator 1350 coupled to a fixed structure 1392. The fixed structure 1392 may be a building, a pole, a lighting structure, a guardrail, or any other fixed structure known in the art. The fixed structure 1392 may be connected to a power grid 1394. The power grid 1394 may be local or global. The turbine generator 1350 may provide power to the fixed structure 1392 and/or the power grid 1394.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A turbine comprising:
a duct comprising a first opening at a first end, a second opening at a second end, and a depression on an internal surface;
a rotor rotatably disposed on the duct and partially disposed within the depression.

2. The turbine of claim 1, wherein the first end is configured to hinge about a horizontal axis, and the second end is configured to hinge about a vertical axis.

3. The turbine of claim 1, wherein at least one of the first end and the second end is at least one of tapered, bent, kinked, hinged, bendable and flexible.

4. The turbine of claim 1 adapted for fluid flow from the first end to the second end, fluid flow causing the rotor to rotate, wherein fluid flow comprises at least one of gas flow, liquid flow, solid particle flow, atomic particle flow, and subatomic particle flow.

5. The turbine of claim 4, wherein a rotating axis of the rotor is disposed substantially perpendicular to a direction of fluid flow.

6. The turbine of claim 4, wherein a rotating axis of the rotor is disposed substantially parallel to a direction of fluid flow.

7. A turbine generator comprising at least one turbine as in claim 1 coupled to at least one generator.

8. The turbine generator of claim 7, wherein the at least one turbine is coupled to the at least one generator using at least one of a shaft connection, a belt connection, and a gear connection.

9. A turbine generator system comprising at least one turbine generator as in claim 7 coupled to an electrical system.

10. A turbine generator system comprising at least one turbine generator as in claim 7 coupled to a vehicle.

11. The turbine generator system of claim 10, wherein the at least one turbine generator is coupled to an electrical circuit of the vehicle.

12. The turbine generator system of claim 10, wherein the vehicle is one of a land vehicle, a watercraft, an aircraft, and a spacecraft.

13. A turbine generator system comprising at least one turbine generator as in claim 7 coupled to a fixed structure.

14. The turbine generator system of claim 13, wherein the fixed structure is one of a building, a pole, a lighting structure, and a guardrail.

15. The turbine generator system of claim 13, wherein the fixed structure is connected to a power grid.
